(19) United States
(12) Patent Application Publication
(10) Pub. No.: US 2026/0354396 A1
(43) Pub. Date: Nov. 12, 2026

(54) Rehang Device For Poultry Processing

(71) Applicant: Georgia Tech Research Corporation, Atlanta, GA (US)

(72) Inventor: Konrad Ahlin, Atlanta, GA (US)

(21) Appl. No.: 19/134,814

(22) PCT Filed: Jan. 19, 2024
(86) PCT No.: PCT/US2024/012120

§ 371 Date: Jun. 2, 2025

Related U.S. Application Data
(60) Provisional application No. 63/480,584, filed on Jan. 19, 2023.

(51) Int. Cl. A22C 21/00

(52) U.S. Cl. CPC A22C 21/0053; A22C 21/0007

(57) ABSTRACT

An exemplary embodiment of the present disclosure provides a poultry rehang system, comprising a first conveyor line and a first placement mat. The first conveyor line can comprise a plurality of shackles. Each shackle can have a first aperture configured to receive a first leg of a first WOG and a second aperture configured to receive a second leg of the first WOG. The first placement mat can have a topography configured to passively align the first and second legs of the first WOG with the respective first and second apertures of the shackle, such that linear motion of the first WOG on the first placement mat in a direction towards the shackle causes the first leg of the first WOG to be received in the first aperture and the second leg of the first WOG to be received in the second aperture.

### CROSS-REFERENCE TO RELATED APPLICATIONS

This application claims the benefit of U.S. Provisional Application Ser. No. 63/480,584 filed on 19 Jan. 2023, which is incorporated herein by reference in its entirety as if fully set forth below.

### FIELD OF THE DISCLOSURE

The various embodiments of the present disclosure relate generally to poultry processing, and more particularly, to rehang devices for poultry processing.

### BACKGROUND

In chicken processing, a worker must hang a WOG (without-giblet, a partially processed poultry product) onto a moving shackle line. This step is a necessary task in processing, but it is also difficult and dangerous. A line worker is currently required to manually pick up a five-pound bird out of a bin or off of a conveyor, lift the carcass to about head-height, and hang the legs of the bird onto a moving shackle. This action is then repeated about 5-10 times per minute. This task requires a person to have both strength and endurance, and, as a consequence, it is difficult to staff these positions. Accordingly, there is a need for a device to assist in the rehang process. The present disclosure provides such devices.

### BRIEF SUMMARY

An exemplary embodiment of the present disclosure provides a poultry rehang system, comprising a first conveyor line and a first placement mat. The first conveyor line can comprise a plurality of shackles. Each shackle can have a first aperture configured to receive a first leg of a first WOG and a second aperture configured to receive a second leg of the first WOG. The first placement mat can have a topography configured to passively align the first and second legs of the first WOG with the respective first and second apertures of the shackle, such that linear motion of the first WOG on the first placement mat in a direction towards the shackle causes the first leg of the first WOG to be received in the first aperture and the second leg of the first WOG to be received in the second aperture.

In any of the embodiments disclosed herein, the first placement mat can be located on a second conveyor line comprising a plurality of placement mats, in which the plurality of placement mats can comprise the first placement mat.

In any of the embodiments disclosed herein, the first conveyor and second conveyor can be configured to move at the same speed.

In any of the embodiments disclosed herein, the first placement mat can have a topography configured to place the first and second legs of the first WOG in a first horizontal plane, and at least a first portion of the first conveyor line can be configured to convey the first shackle in a first direction such that the first and second apertures of the first shackle pass by the first placement mat in the first horizontal plane.

In any of the embodiments disclosed herein, the first placement mat can be located on a second conveyor line comprising a plurality of placement mats, the plurality of placement mats can comprise the first placement mat, and at least a portion of the second conveyor line can be configured to convey the plurality of placement mats in a second direction parallel with the first direction.

In any of the embodiments disclosed herein, at least a second portion of the first conveyor line prior to the first portion of the first conveyor line in a direction of travel of the first conveyor line can be configured to convey the first shackle such that the first and second apertures of the first shackle pass through a second horizontal plane above the first horizontal plane.

In any of the embodiments disclosed herein, at least a third portion of the first conveyor line after to the first portion of the first conveyor line in a direction of travel of the first conveyor line can be configured to convey the first shackle such that the first and second apertures of the first shackle pass through the second horizontal plane.

In any of the embodiments disclosed herein, the placement mat can comprise first, second, and third recesses. The first recess can be configured to receive a torso portion of the first WOG. The second recess can be configured to receive the first leg of the first WOG. The third recess can be configured to receive the second leg of the first WOG.

In any of the embodiments disclosed herein, the first recess can be positioned between the first and second recesses.

In any of the embodiments disclosed herein, the first recess can be at a depth greater than depths of the second and third recesses.

Another embodiment of the present disclosure provides a method of rehanging poultry, the method comprising: conveying, using a first conveyor line, a plurality of shackles, each of the shackles having a first aperture for receiving a first leg of a respective without giblet chicken (WOG); conveying, using a second conveyor line, a plurality of placement mats, each of the placement mats having a topography configured to passively align the first leg of the respective WOG with the first aperture of the respective shackle; and inserting the first leg of the respective WOG into the first aperture.

In any of the embodiments disclosed herein, inserting the first leg of the respective WOG into the first aperture can comprise sliding the WOG in a horizontal direction from the respective placement mat towards the respective shackle.

In any of the embodiments disclosed herein, the first conveyor line can comprise a first portion at a first height and a second portion at a second height lower than the first height, and the second portion can be downstream of the first portion.

In any of the embodiments disclosed herein, when the shackles are on the second portion of the first conveyor line, the first apertures of the shackles can be in a same horizontal plane as recesses in respective placement mats.

In any of the embodiments disclosed herein, the first conveyor line can further comprise a third portion at a third height greater than the second height, and the third portion can be downstream of the second portion.

In any of the embodiments disclosed herein, when inserting the first leg of the respective WOG into the first aperture, the respective placement mat and the respective shackle can be traveling at the same speed.

In any of the embodiments disclosed herein, the method can further comprise placing WOGs on the plurality of placement mats.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides a perspective view of a shackle and placement mat, in accordance with some embodiments of the present disclosure.

FIG. 2 provides a perspective view of a poultry rehang system, in accordance with some embodiments of the present disclosure.

FIG. 3 provides a perspective view of a poultry rehang system, in accordance with some embodiments of the present disclosure.

FIG. 4 provides a top view of a poultry rehang system, in accordance with some embodiments of the present disclosure.

FIG. 5 provides a side view of a poultry rehang system, in accordance with some embodiments of the present disclosure.

FIG. 6 provides a perspective view of a portion of a poultry rehang system, in accordance with some embodiments of the present disclosure.

FIG. 7 provides a perspective view of a shackle, in accordance with some embodiments of the present disclosure.

FIGS. 8A-B provide schematic side views of a placement mat, in accordance with some embodiments of the present disclosure.

FIG. 9 provides a flow chart of a method of rehanging poultry, in accordance with some embodiments of the present disclosure.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

The present disclosure provides a rehang systems for use in poultry processing. The systems are designed to alleviate and simplify the process of hanging WOGs onto a moving shackle line. As discussed above, in conventional systems, even a singulated WOG can be a very difficult object to manipulate, and workers will almost always employ both hands in shackling the WOG. The rehang systems disclosed herein can enable an operator to use a single hand to align the bird with only minimal lifting. This device can allow for a more ergonomic action using less strength, which can reduce the risk of injury from repeated lifting. In addition to the benefits to the operator, this device can benefit the production flow as well. Every unit can be designed to handle multiple WOGs simultaneously, allowing WOGs to be placed onto the moving shackle line without downtime.

In order to perform the rehang operation, the OHRD comprises several key features. The diagrams depicted herein are conceptualizations of processes to perform this task. The disclosure, however, is not limited to the specific embodiments shown and described in herein. Rather, as those skilled in the art, the exact details or mechanisms herein can be altered within the spirt of the disclosure. Nevertheless, certain devices and intentions employed in some embodiments of the rehang systems are described below.

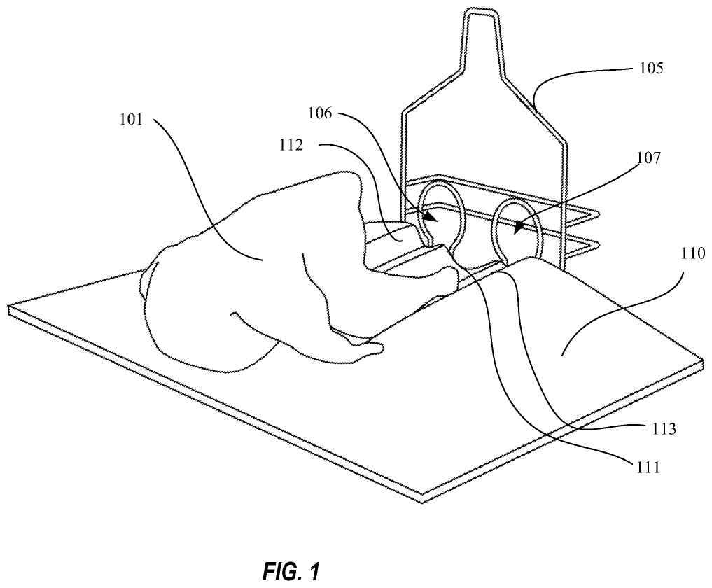

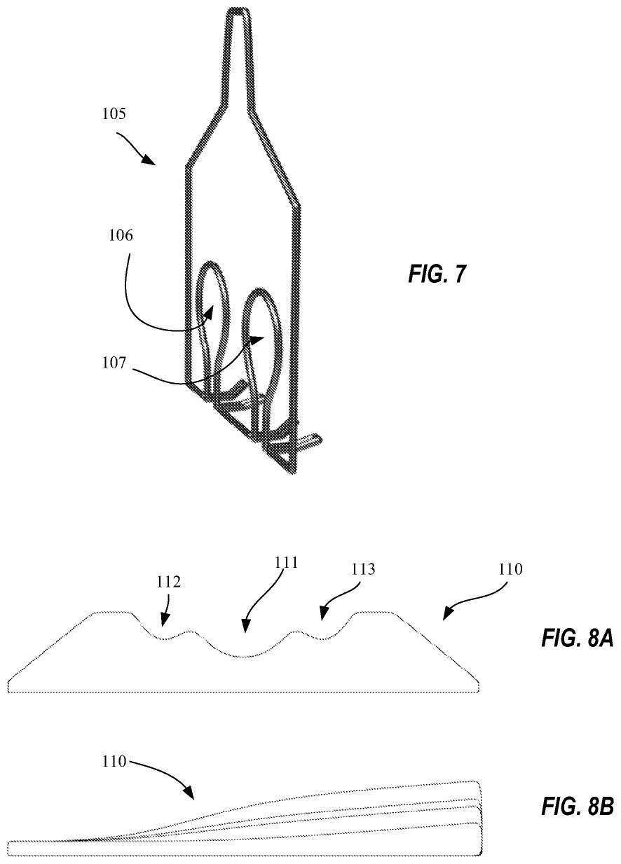

Various embodiments of the present disclosure allow workers in poultry processing plants to rehang WOGs without the need to lift the WOG and hang the WOG on a moving shackle on a conveyor. As shown in FIG. 1 and FIG. 7, the shackle 105 can comprise one or more apertures 106 107 configured receive legs of the WOG 101. For example, the shackle 105 can comprise a first aperture 106 configured to receive a first leg of the WOG 101 and a second aperture 107 configured to receive a second leg of the WOG 101. Embodiments of the present disclosure, however, are not limited to the shackle design shown in the figures. Rather, various embodiments of the present disclosure can employ many different shackle designs for suspending WOGs.

To allow the WOG 101 to be hung from the shackle 105 without having to lift the WOG 101 to an overhead shackle, some embodiments of the present disclosure employ a placement mat 110, as shown in FIG. 1. The placement mat 110 can be positioned such that a WOG 101 on the placement mat 110 can be pushed/slid forward in a direction of the shackle 105 so that legs of the WOG 101 are received into the apertures 106 107 of the shackle 105. Once one or more legs of the WOG 101 are received in the aperture(s) 106 107, when the shackle 105 is raised, e.g., by a conveyor, the WOG 101 can be suspended from the shackle 105, without having to have been lifted onto the shackle 105 by the worker.

As shown in FIG. 1, the placement mat 110 can have a topography configured to passively align the first and second legs of a WOG 101 with the respective first 106 and second 107 apertures of the shackle 105. For example, the placement mat 110 can have one or more recesses 111 112 113. In some embodiments, the placement mat 110 can comprise a first recess 111 configured to receive a torso portion of the WOG 101. In some embodiments, the placement mat 110 can further comprise a second recess 112 configured to receive the first leg of the WOG 101. In some embodiments, the placement mat 110 can further comprise a third recess 113 configured to receive the second leg of the WOG 101. The placement mat 110 shown in FIG. 1 includes such first 111, second 112, and third 113 recesses. Additionally, as shown in FIG. 1, the recesses 111 112 113 can be elongated to allow for linear motion of the WOG 101 in the direction of the shackle 105. Thus, the recesses 111 112 113 can passively align the WOG 101 such that linear motion of the WOG on the placement mat 110 in a direction towards the shackle 105 causes a first leg of the WOG 101 to be received in the first aperture 106 and the second leg of the first WOG 101 to be received in the second aperture 107. FIGS. 8A-B provide side views of the profile of exemplary placement mats. As shown in the FIG. 8A, the first recess 111 can be at a depth greater than depths of the second 112 and third 113 recesses. The present disclosure, however, is not limited to the specific placement mat design shown in the figures.

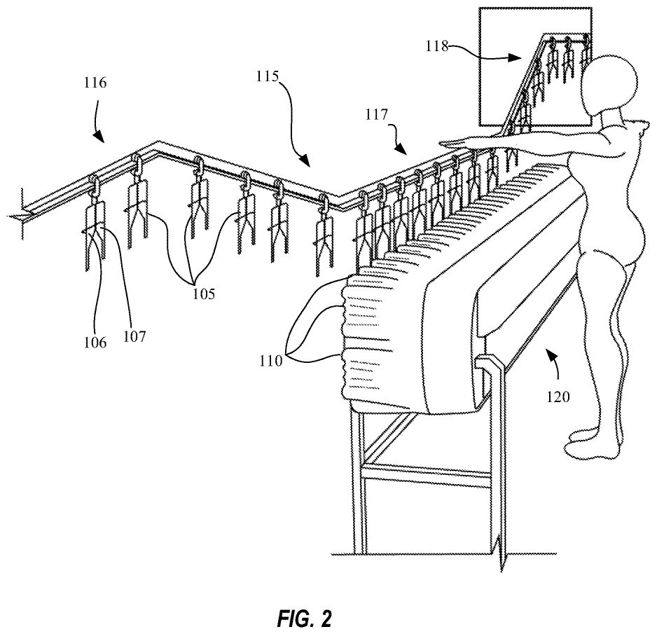

As shown in FIG. 2, an exemplary embodiment of the present disclosure provides a poultry rehang system, comprising a first conveyor line 115 and a second conveyor line 120. The first conveyor line 115 can comprise a plurality of shackles 105 suspended therefrom. The first conveyor line 115 can be used to transport suspended WOGs to various locations in a poultry processing plant. The second conveyor line 120 can comprise a plurality of placement mats 110. In some embodiments, as shown in FIG. 2, the second conveyor 120 can be configured as a belt conveyor. In some embodiments, the plurality of placement mats 110 can be integrated with the surface of the second conveyor 120.

As shown in FIG. 2, placement mats 110 can have a topography configured to place the first and second legs of a WOG in a horizontal plane, and at least a portion of the first conveyor line 115 can be configured to convey shackles 105 in a direction such that the first 106 and second 107 apertures of a shackle 105 pass by the placement mats 110 in the horizontal plane. For example, the first conveyor 115 can have a first portion 116, a second portion 117, and a third portion 118. As the first conveyor 115 moves, the first portion 116 can be upstream of the second conveyor line 120. At the location where the first conveyor 115 comes in proximity to the second conveyor 120, a second portion 117 of the first conveyor 115 can dip down to a lower height than the first portion 116 such that the shackles 105 are substantially in the same horizontal plane as the placement mats 110 on the second conveyor 120. At this point, the WOGs can be slid forward to engage the shackles 105. As the first conveyor 115 continues to move along, a third portion 118 of the first conveyor 115 downstream of the second portion 117 can rise up to a height above the second portion 117 of the first conveyor 115. As the height increases, the WOGs (not shown) can be raised off the placement mats 110 and become suspended on the shackles 105.

As shown in FIG. 2, the second portion 117 of the first conveyor 115 can move the shackles 105 in a direction substantially parallel to the direction of movement of the placement mats 110 on the second conveyor 120. Additionally, in some embodiments, the first 115 and second 120 conveyors can be configured to move at about the same speed such that the shackles 105 and placement mats 120 are aligned along the length of the second conveyor 120 to allow the WOGs to engage with the shackles 105.

The configuration of the first conveyor 115, however, is not limited to the specific configurations shown in the figures. For example, in some embodiments, the first 116 and second 117 portions of the first conveyor 115 can be at substantially the same height. In some embodiments, the second 117 and third 118 portions of the first conveyor 115 can be at substantially the same height, such that when a shackle 105 of the first conveyor 115 passes by end of the second conveyor 120, the WOG can drop at the end of the second conveyor 120, thus causing the leg(s) of the WOG to engage the aperture(s) 106 107 of the shackle 105 and be suspended from the shackle 105.

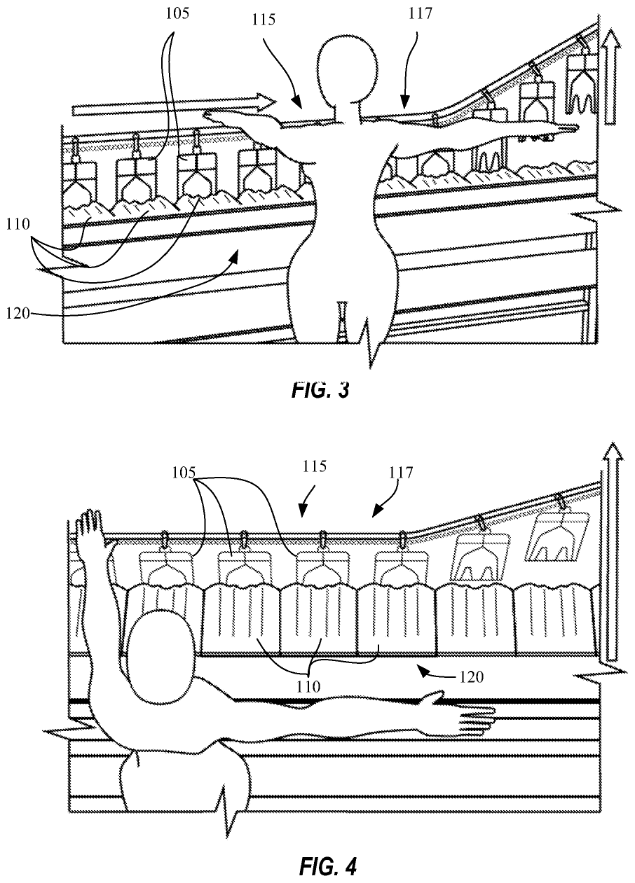

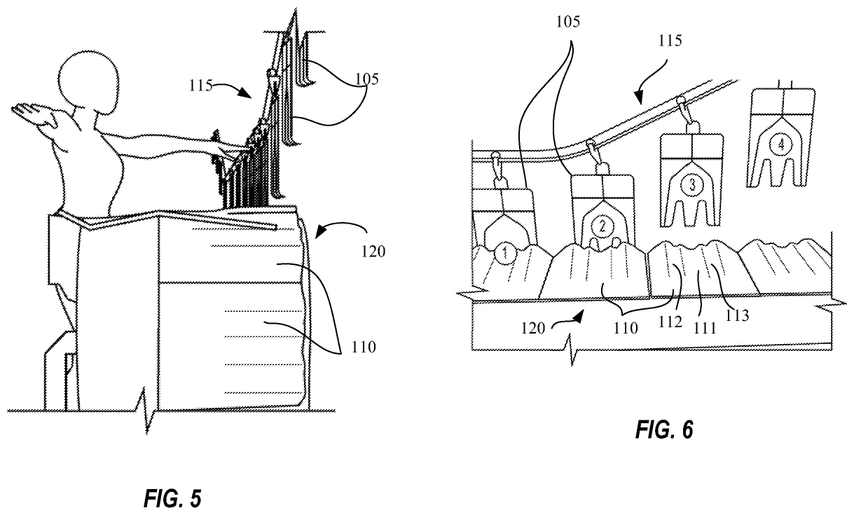

FIGS. 3-6 provides schematics of various views of portions of the poultry rehang system shown in FIG. 2. FIG. 3 provides a side view looking in a direction perpendicular to the direction of travel. As shown in FIG. 3, the second portion 117 of the first conveyor 115 is in substantially the same horizontal plane as the second conveyor 120 and then rises after it passes by the second conveyor 120. FIG. 4 shows a top view of the same portion of the poultry rehang system shown in FIG. 3. FIG. 5 shows an end view of the poultry rehang system shown in FIG. 2, looking towards the system in a direction opposite to the direction of travel of the first conveyor 115. FIG. 6 provides a side view of a portion of the poultry rehang system as the first conveyor 115 rises in height after passing by the second conveyor 120. As shown in FIG. 6, the height of the shackle 105 increases from shackle position 1 through shackle position 4, during which time, the WOG (not shown) would be lifted off of the second conveyor 120 and suspended from the shackle 105.

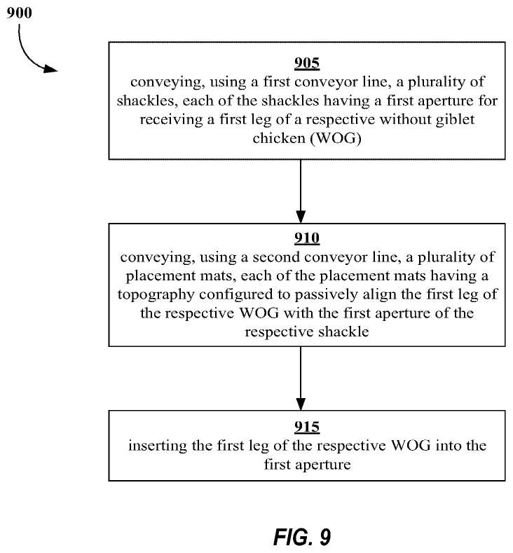

Another embodiment of the present disclosure provides a method of rehanging poultry. FIG. 9 provides a flow chart illustrating an exemplary method. The method 900 can comprise: conveying, using a first conveyor line, a plurality of shackles, each of the shackles having a first aperture for receiving a first leg of a respective without giblet chicken (WOG) 905; conveying, using a second conveyor line, a plurality of placement mats, each of the placement mats having a topography configured to passively align the first leg of the respective WOG with the first aperture of the respective shackle 910; and inserting the first leg of the respective WOG into the first aperture 915. In any of the embodiments disclosed herein, inserting the first leg of the respective WOG into the first aperture 910 can comprise sliding the WOG in a horizontal direction from the respective placement mat towards the respective shackle.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A poultry rehang system comprising:
a first conveyor line comprising a plurality of shackles, each shackle having a first aperture configured to receive a first leg of a first without giblet chicken (WOG) and a second aperture configured to receive a second leg of the first WOG; and
a first placement mat having a topography configured to passively align the first and second legs of the first WOG with the respective first and second apertures of the shackle, such that linear motion of the first WOG on the first placement mat in a direction towards the shackle causes the first leg of the first WOG to be received in the first aperture and the second leg of the first WOG to be received in the second aperture.

2. The poultry rehang system of claim 1, wherein the first placement mat is located on a second conveyor line comprising a plurality of placement mats, one of which is the first placement mat.

3. The poultry rehang system of claim 2, wherein the first conveyor and second conveyor are configured to move at the same speed.

4. The poultry rehang system of claim 1, wherein:
the first placement mat has a topography further configured to place the first and second legs of the first WOG in a first horizontal plane; and
at least a first portion of the first conveyor line is configured to convey a first shackle of the plurality of shackles in a first direction such that the first and second apertures of the first shackle pass by the first placement mat in the first horizontal plane.

5. The poultry rehang system of claim 4, wherein:
the first placement mat is located on a second conveyor line comprising a plurality of placement mats, one of which is the first placement mat; and
at least a portion of the second conveyor line is configured to convey the plurality of placement mats in a second direction parallel with the first direction.

6. The poultry rehang system of claim 4, wherein at least a second portion of the first conveyor line prior to the first portion of the first conveyor line in a direction of travel of the first conveyor line is configured to convey the first shackle such that the first and second apertures of the first shackle pass through a second horizontal plane above the first horizontal plane.

7. The poultry rehang system of claim 6, wherein at least a third portion of the first conveyor line after to the first portion of the first conveyor line in a direction of travel of the first conveyor line is configured to convey the first shackle such that the first and second apertures of the first shackle pass through the second horizontal plane.

8. The poultry rehang system of claim 1, wherein the first placement mat comprises:
a first recess configured to receive a torso portion of the first WOG;
a second recess configured to receive the first leg of the first WOG; and
a third recess configured to receive the second leg of the first WOG.

9. The poultry rehang system of claim 8, wherein the first recess is positioned between the second and third recesses.

10. The poultry rehang system of claim 8, wherein the first recess is at a depth greater than depths of the second and third recesses.

11. A method of rehanging poultry comprising:
conveying, using a first conveyor line, a plurality of shackles, each of the shackles having a first aperture for receiving a first leg of a respective without giblet chicken (WOG);
conveying, using a second conveyor line, a plurality of placement mats, each of the placement mats having a topography configured to passively align the first leg of the respective WOG with the first aperture of the respective shackle; and
inserting the first leg of the respective WOG into the first aperture by sliding the WOG in a horizontal direction from the respective placement mat towards the respective shackle.

12. (canceled)

13. The method of claim 11, wherein the first conveyor line comprises a first portion at a first height and a second portion at a second height lower than the first height, the second portion downstream of the first portion.

14. The method of claim 13, wherein, when the shackles are on the second portion of the first conveyor line, the first apertures of the shackles are in a same horizontal plane as recesses in respective placement mats.

15. The method of claim 13, wherein the first conveyor line further comprises a third portion at a third height greater than the second height, the third portion downstream of the second portion.

16. The method of claim 11, wherein, when inserting the first leg of the respective WOG into the first aperture, the respective placement mat and the respective shackle are traveling at the same speed.

17. The method of claim 11, further comprising placing WOGs on the plurality of placement mats.

18. The method of claim 11, wherein each placement mat comprises:
a first recess configured to receive a torso portion of the first WOG;
a second recess configured to receive the first leg of the first WOG; and
a third recess configured to receive the second leg of the first WOG.

19. The method of claim 18, wherein the first recess is positioned between the second and third recesses.

20. The method of claim 18, wherein the first recess is at a depth greater than depths of the second and third recesses.
